(19) United States
(12) Patent Application Publication
(10) Pub. No.: US 2025/0026457 A1
(43) Pub. Date: Jan. 23, 2025

(54) ARRANGEMENT OF LOCAL STRUCTURES FOR TLP-TYPE FLOATING OFFSHORE WIND TURBINE PLATFORM STRESS DISTRIBUTION AND STRENGTH ENHANCEMENT

(71) Applicant: KOREA INSTITUTE OF OCEAN SCIENCE & TECHNOLOGY, Busan (KR)

(72) Inventors: Kyong Hwan KIM, Daejeon (KR); Ji Yong PARK, Daejeon (KR); Yoon Jin HA, Daejeon (KR); Se Wan PARK, Daejeon (KR); Gil Won KIM, Sejong (KR); Chang Hyuck LIM, Daejeon (KR); Byung Soo KIM, Daejeon (KR)

(73) Assignee: KOREA INSTITUTE OF OCEAN SCIENCE & TECHNOLOGY, Busan (KR)

(21) Appl. No.: 18/673,994

(22) Filed: May 24, 2024

Related U.S. Application Data
(63) Continuation of application No. PCT/KR2024/004519, filed on Apr. 5, 2024.

(30) Foreign Application Priority Data
Jul. 19, 2023 (KR) 10-2023-0093742

(51) Int. Cl. B63B 35/44; B63B 1/10

(52) U.S. Cl. CPC B63B 35/4406; B63B 1/107; B63B 2035/446

(57) ABSTRACT

Proposed is an arrangement of local structures for TLP-type floating offshore wind turbine platform stress distribution and strength enhancement, the arrangement being characterized in that a plurality of supporting members of which at least one is elongated in a different direction protrudes from the bottom plate of a node, so the top plate of the node to which load is applied by a wind turbine is supported by the supporting members, stress is distributed, and damage to the top plate is prevented such that the wind turbine can be stably supported through the node.

### CROSS-REFERENCE TO RELATED APPLICATIONS

This application is a continuation of International Application No. PCT/KR2024/004519 filed on Apr. 5, 2024, which claims priority to Korean Patent Application No. 10-2023-0093742 filed on Jul. 19, 2023, the entire contents of which are herein incorporated by reference.

### TECHNICAL FIELD

The present disclosure relates to an offshore wind turbine platform and, in more detail, an arrangement of local structures for TLP-type floating offshore wind turbine platform stress distribution and strength enhancement, the arrangement supporting a top plate of a node, which supports a wind turbine, with a plurality of supporting members disposed like leaf veins so that the wind turbine is stably supported through the node because when load is applied to the top plate of the node, stress is distributed through the supporting members and damage to the top plate is prevented.

### BACKGROUND ART

Ecofriendly renewable energy is in the spotlight as environmental contamination is becoming worse due to use of fossil fuel.

Ecofriendly renewable energy has the advantage that it is clean and has no risk of exhaustion and can be recycled without contamination, so the range of application is increasing.

Meanwhile, one type of ecofriendly renewable energy is wind energy that uses a wind power generator.

A wind power generator has a turbine mounted on a vertically-installed tower and the turbine is rotated by wind, whereby power can be produced.

However, since the size of the turbine of a wind power generator is considerable, a relatively wide installation space is required, so there is a problem that an installation place is limited.

Further, since considerable noise is generated when the turbine of a wind power generator is rotated, there is a problem that such noise is a factor in civil complaints.

In order to solve these problems, such an ‘offshore wind power generator’ disclosed in Korean Patent Application Publication No. 10-2023-0026975, etc. is recently increasingly used.

Offshore wind power generators are installed on the sea far from private houses, etc., so it is easy to secure spaces and they can be free from civil petitions due to noise.

A tower of such offshore wind power generators is installed on a floating platform composed of a plurality of pontoons generally circumferentially disposed and a node connected to the pontoons, in detail, is installed at the center of the top plate of the node.

Accordingly, load of several tons to tens of tons acts on the top plate of the node, so when the node itself is weak, supporting of the tower may become unstable, and accordingly, there is a problem that a large accident may occur.

For this reason, it is being tried in this field to develop an offshore wind turbine platform that prevents damage to a top plate of a node so that a wind turbine can be stably supported through the node by smoothly distributing stress when load is applied to the top plate of the node by the wind turbine, but there is no satisfactory result so far.

### RELATED ART DOCUMENT

### Patent Document

(Patent Document 1) Korean Patent Application Publication No. 10-2023-0026975

### DISCLOSURE

### Technical Problem

The present disclosure has been made in an effort to solve the problems of the related art described above and an objective of the present disclosure is to provide an offshore wind turbine platform that can stably support a wind turbine through a node by preventing damage to a top plate of a node by smoothly distributing stress when load is applied to the top plate of the node by the wind turbine.

### Technical Solution

In order to achieve the objectives,

the present disclosure proposes an arrangement of local structures for TLP-type floating offshore wind turbine platform stress distribution and strength enhancement, the arrangement including: a node providing a seat surface for a wind turbine through a top plate and having a first flat surface formed in any one direction, a second flat surface formed in another direction, and a third flat surface formed in another direction; and a plurality of pontoons generating buoyancy on the sea by being connected to the node and elongated in three directions by being connected to the first flat surface, the second flat surface, and the third flat surface of the node, respectively, wherein the node comprises a plurality of supporting members that protrudes upward from a bottom plate disposed at a predetermined distance under the top plate and of which at least one is elongated in a different direction, and the top plate is supported by the supporting members, so stress generated by load applied to the top plate by the wind turbine is distributed.

### Advantageous Effects

According to the arrangement of local structures for TLP-type floating offshore wind turbine platform stress distribution and strength enhancement of the present disclosure, since a plurality of supporting members of which at least one is elongated in a different direction protrudes from the bottom plate of a node, the top plate of the node to which load is applied by a wind turbine can be supported by the supporting members, so stress is distributed and damage to the top plate is prevented, and accordingly, the wind turbine can be stably supported through the node. The arrangement of local structures for TLP-type floating offshore wind turbine platform stress distribution and strength enhancement of the present disclosure includes: a plurality of first supporting members that is horizontally elongated from the first flat surface and of which any one and another one are spaced apart from each other; a plurality of second supporting members that is elongated downward at an angle from the second flat surface toward the first supporting members and of which any one and another one are spaced apart from each other; and a plurality of third supporting members that is elongated upward at an angle from the third flat surface toward the first supporting members and of which any one and another one are spaced apart from each other.

Accordingly, stress can be more smoothly distributed in multiple directions by the first supporting member, the second supporting member, and the third supporting member elongated in different directions in a leaf vein-like shape.

Further, according to the arrangement of local structures for TLP-type floating offshore wind turbine platform stress distribution and strength enhancement of the present disclosure, since the supporting members of the node are vertically elongated, interference therebetween is prevented, so attachment/detachment is easy and work convenience can be improved. Further, since there is no bending portion in the entire section of the supporting members, bending is not required, so it is possible to reduce the manufacturing cost. Further, it is easy to add reinforcing members at joints with the flat surfaces in accordance with the level of structural stress, so it is possible to further increase structural stability.

### DESCRIPTION OF DRAWINGS

FIG. 1 is a perspective view of an offshore wind turbine platform to which an arrangement of local structures for TLP-type floating offshore wind turbine platform stress distribution and strength enhancement of the present disclosure has been applied.

FIG. 2 is a partial exploded perspective view of a node in the offshore wind turbine platform to which an arrangement of local structures for TLP-type floating offshore wind turbine platform stress distribution and strength enhancement of the present disclosure has been applied.

FIG. 3 is a cross-sectional view of the node in the offshore wind turbine platform to which an arrangement of local structures for TLP-type floating offshore wind turbine platform stress distribution and strength enhancement of the present disclosure has been applied.

FIG. 4 is an exemplary view showing another arrangement type of supporting members of the node in the offshore wind turbine platform to which an arrangement of local structures for TLP-type floating offshore wind turbine platform stress distribution and strength enhancement of the present disclosure has been applied.

FIG. 5 is an exemplary view showing the case in which at least one of the supporting members of the node is formed to have a different thickness in the offshore wind turbine platform to which an arrangement of local structures for TLP-type floating offshore wind turbine platform stress distribution and strength enhancement of the present disclosure has been applied.

FIG. 6 is an exemplary view showing the case in which protrusions are formed on a finishing plate of the node in the offshore wind turbine platform to which an arrangement of local structures for TLP-type floating offshore wind turbine platform stress distribution and strength enhancement of the present disclosure has been applied.

FIG. 7 is an exemplary view showing an arrangement of the protrusions formed on finishing plates constituting the node in the offshore wind turbine platform to which an arrangement of local structures for TLP-type floating offshore wind turbine platform stress distribution and strength enhancement of the present disclosure has been applied.

### DETAILED DESCRIPTION

Hereinafter, the present disclosure is described in detail on the basis of the accompanying drawings.

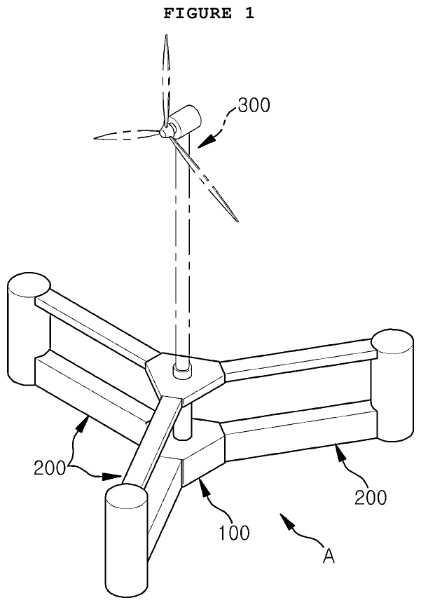

As shown in FIG. 1, an offshore wind turbine platform A to which an arrangement of local structures for TLP-type floating offshore wind turbine platform stress distribution and strength enhancement according to the present disclosure has been applied includes a node 100 and pontoons 200.

The node 100 of the present disclosure provides a seat surface for a wind turbine 300 through a top plate 110 and has a first flat surface 100a formed in any one direction, a second flat surface 100b formed in another direction, and a third flat surface 100c formed in another direction.

Accordingly, the pontoons 200 to be described below are coupled to the first flat surface 100a, the second flat surface 100b, and the third flat surface 100c, respectively, whereby the node 100 and the pontoons 200 can be connected.

The node 100 includes a plurality of supporting members 140 that protrudes upward from a bottom plate 120 disposed at a predetermined distance under the top plate 110 and at least one of which is elongated in a different direction.

Accordingly, the upper ends of the supporting members 140 are in contact with the bottom of the top plate 110, whereby the top plate 110 can be supported by the supporting members 140, and accordingly, stress that is generated by load applied to the top plate 110 by a wind turbine 300 can be distributed.

The supporting members 140 include: a plurality of first supporting members 141 that is horizontally elongated from the first flat surface 100a and of which any one and another one are spaced apart from each other; a plurality of second supporting members 142 that is elongated downward at an angle from the second flat surface 100b toward the first supporting members 141 and of which any one and another one are spaced apart from each other; and a plurality of third supporting members 143 that is elongated upward at an angle from the third flat surface 100c toward the first supporting members 141 and of which any one and another one are spaced apart from each other, whereby a leaf vein-like shape is formed by the first supporting members 141, the second supporting members 142, and the third supporting members 143. Accordingly, stress that is generated by load applied to the top plate 110 can be smoothly distributed in multiple directions.

The first supporting members 141, the second supporting members 142, and the third supporting members 143 each may be disposed such that any one and another one are disposed with a same gap between any one end and another end in the longitudinal direction of the first flat surface 100a, the second flat surface 100b, and the third flat surface 100c, respectively, but they are not limited thereto.

That is, the first supporting members 141, the second supporting members 142, and the third supporting members 143 each may be disposed such that the gap between any one and another one thereof decreases toward the middle portion from any one end in the longitudinal direction of the first flat surface 100a, the second flat surface 100b, and the third flat surface 100c, respectively.

Accordingly, the center portion of the top plate 110 can be particularly firmly supported by the first supporting members 141, the second supporting members 142, and the third supporting members 143.

Further, at least one of each of the first supporting members 141, the second supporting members 142, and the third supporting members 143 is formed to have a different thickness, that is, at least one is formed thicker, whereby the top plate 110 can be more firmly supported.

Further, at least one of each of the first supporting members 141, the second supporting members 142, and the third supporting members 143 are formed to have a different length, that is, at least one is formed longer, whereby it is possible to more widely support the top plate 110.

The node 100 includes a finishing plate 130 elongated from the edge of the top plate 110 to the edge of the bottom plate 120.

Accordingly, the top plate 110 can also be supported by the finishing plate 130 and water can be prevented from flowing inside between the top plate 110 and the bottom plate 120 by the finishing plate 130.

The finishing plate 130 includes a plurality of protrusions 131 protruding from the inner surface of the finishing plate 130 with an upper end in contact with the bottom of the top plate 110 and a lower end in contact with the top of the bottom plate 120, whereby the top plate 110 can also be supported by the protrusions 131.

The protrusions 131 are disposed between any one and another one of the first supporting members 141, between any one and another one of the second supporting members 142, and between any one and another one of the third supporting members 143, respectively, so when the finishing plate 130 is installed, interference due to contact of the protrusions 131 with the supporting members 140 can be prevented.

Coupling of the supporting members 140 and the top plate 110, coupling of the top plate 110 and the finishing plate 130, and coupling of the bottom plate 120 and the finishing plate 130 at the node 100 are made by welding, so coupling of the supporting members 140 and the top plate 110, coupling of the top plate 110 and the finishing plate 130, and coupling of the bottom plate 120 and the finishing plate 130 can be stably maintained and inflow of water through the joints can also be prevented.

The pontoons 200 of the present disclosure are connected to the node 100 to generate buoyancy on the sea and are elongated in three directions by being connected to the first flat surface 100a, the second flat surface 100b, and the third flat surface 100c, respectively.

Accordingly, as the pontoons 200 generate buoyancy on the sea, the offshore wind turbine platform A to which the arrangement of local structures for TLP-type floating offshore wind turbine platform stress distribution and strength enhancement according to the present disclosure has been applied can be installed on the sea.

Any common structures and manners can be used for the pontoons 200 as long as they can generate buoyancy on the sea, so the pontoons 200 are not described in detail.

Meanwhile, the pontoons 200 and the node 100 can be coupled in any common manner as long as the coupled state can be firmly maintained, and for example, fastening that uses fasteners or welding may be used.

In the offshore wind turbine platform A to which the arrangement of local structures for TLP-type floating offshore wind turbine platform stress distribution and strength enhancement according to the present disclosure has been applied, stress can be smoothly distributed in the top plate 110 of the node 100. This is described in detail hereafter.

A wind turbine 300 is seated at the center on the top plate 110 of the node 100.

In this configuration, since the first flat surface 100a is formed in any one direction, the second flat surface 100b is formed in another direction, and the third flat surface 100c is formed in another direction on the node 100, it is possible to generate buoyancy on the sea by coupling the pontoons 200 to the first flat surface 100a, the second flat surface 100b, and the third flat surface 100c, respectively, and accordingly, the wind turbine 300 can be floated on the sea.

However, since the wind turbine 300 is a very large structure of which the length and width reach tens of meters, considerably load acts on the top plate 110 of the node 100. Accordingly, when stress generated by load concentrates at a portion of the top plate 110, the top plate 110 may be damaged and supporting of the wind turbine 300 may become unstable.

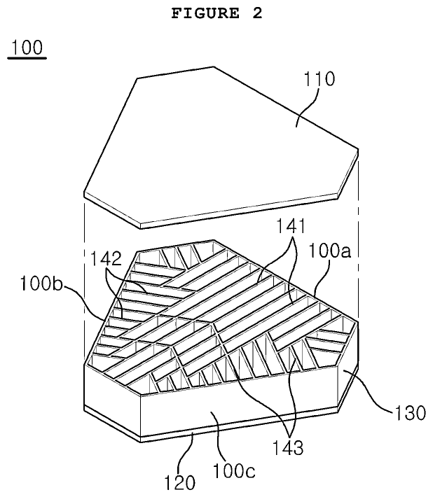

However, in the present disclosure, a plurality of supporting members 140 of which at least one is elongated in a different direction protrudes on the bottom plate 120 of the node 100, as shown in FIG. 2, and the top plate 110 of the node 100 to which load is applied by the wind turbine 300 is supported by the supporting members 140, so stress is distributed by the supporting members 140 and damage to the top plate 110 is prevented. Accordingly, the wind turbine 300 can be stably supported through the node 100.

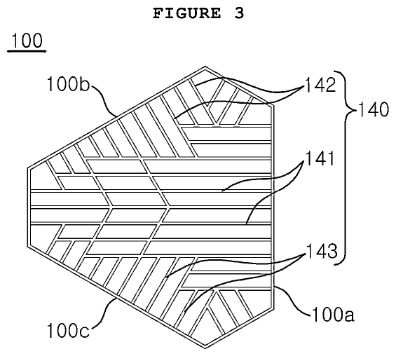

The supporting members 140 of the present disclosure, as shown in FIG. 3, include: a plurality of first supporting members 141 that is horizontally elongated from the first flat surface 100a of the node 100 and of which any one and another one are spaced apart from each other; a plurality of second supporting members 142 that is elongated downward at an angle from the second flat surface 100b of the node 100 toward the first supporting members 141 and of which any one and another one are spaced apart from each other; and a plurality of third supporting members 143 that is elongated upward at an angle from the third flat surface 100c of the node 100 toward the first supporting members 141 and of which any one and another one are spaced apart from each other, whereby the first supporting members 141, the second supporting members 142, and the third supporting members 143 are elongated in different directions in a leaf vein-like shape. Accordingly, stress that is generated by load applied to the top plate 110 can be more smoothly distributed in multiple directions, so the wind turbine 300 can be more stably supported through the node 100.

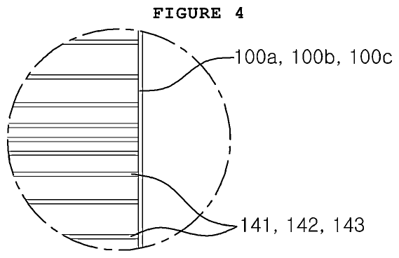

In this configuration, as shown in FIG. 4, the first supporting members 141, the second supporting members 142, and the third supporting members 143 each may be disposed such that the gap between any one and another one thereof decreases toward the middle portion from any one end in the longitudinal direction of the first flat surface 100a, the second flat surface 100b, and the third flat surface 100c, respectively, so the center portion of the top plate 110 can be firmly supported by the supporting members 141, the second supporting members 142, and the third supporting members 143, and accordingly, damage to the center portion of the top plate 110 at which the load of the wind turbine 300 concentrates can be further prevented.

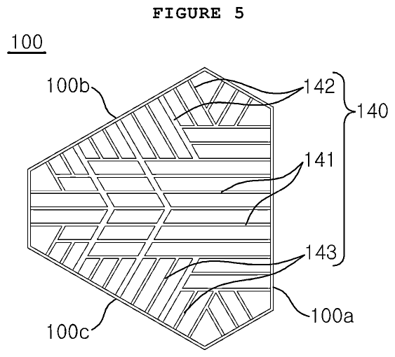

Further, as shown in FIG. 5, at least one of each of the first supporting members 141, the second supporting members 142, and the third supporting members 143 may be formed to have a different thickness, that is, at least one may be formed thicker, so the top plate 110 can be more firmly supported by the first supporting members 141, the second supporting members 142, and the third supporting members 143.

Further, at least one of each of the first supporting members 141, the second supporting members 142, and the third supporting members 143 may be formed to have a different length, that is, at least one may be formed longer, so the top plate 110 can be more widely supported through the first supporting members 141, the second supporting members 142, and the third supporting members 143.

Further, in the present disclosure, the node 100 includes the finishing plate 130 elongated from the edge of the top plate 110 to the edge of the bottom plate 120, so the top plate 110 can also be supported by the finishing plate 130.

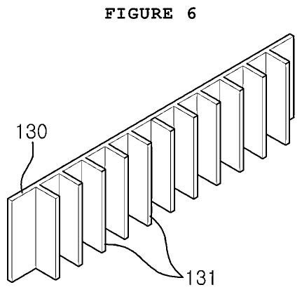

The finishing plate 130, as shown in FIG. 6, includes a plurality of protrusions 131 protruding from the inner surface of the finishing plate 130 with an upper end in contact with the bottom of the top plate 110 and a lower end in contact with the top of the bottom plate 120, whereby the top plate 110 can also be supported by the protrusions 131.

However, since the protrusions 131 are formed on the finishing plate 130, installation of the finishing plate 130 may be interfered with by the protrusions 131.

That is, the protrusions 131 are in contact with at least one of the first supporting members 141, the second supporting members 142, and the third supporting members 143, the finishing plate 130 may come off and installation thereof may be difficult.

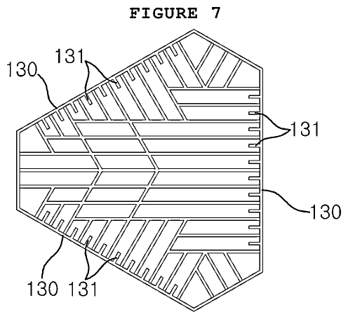

However, in the present disclosure, as shown in FIG. 7, the protrusions 131 are disposed between any one and another one of the first supporting members 141, between any one and another one of the second supporting members 142, and between any one and another one of the third supporting members 143, respectively, so when the finishing plate 130 is installed, interference due to contact of the protrusions 131 with the supporting members 140 can be prevented.

Since the present disclosure described above is not limited to the embodiment described above, the present disclosure may be changed without departing from the spirit described in following claims and such change is included in the protection range of the present disclosure defined in the claims.

[Description of Reference Numerals]

| | |
|---|---|
| 100: node | 100a: first flat surface |
| 100b: second flat surface | 100c: third flat surface |
| 110: top plate | 120: bottom plate |
| 130: finishing plate | 131: protrusion |
| 140: supporting member | 141: first supporting member |
| 142: second supporting member | 143: third supporting member |
| 200: pontoon | 300: wind turbine |
| A: offshore wind turbine platform | |

### INDUSTRIAL APPLICABILITY

Since the top plate of the node supporting a wind turbine is supported by a plurality of supporting members disposed in a leaf vein-like shape, when load is applied to the top plate of the node by the wind turbine, stress is distributed by the supporting members and damage to the top plate is prevented, so the wind turbine can be stably supported through the node. Accordingly, the present disclosure has industrial applicability in relation to manufacturing of a TLP-type floating offshore wind turbine platform.

1. An arrangement of local structures for TLP-type floating offshore wind turbine platform stress distribution and strength enhancement, the arrangement comprising:
a node providing a seat surface for a wind turbine through a top plate and having a first flat surface formed in any one direction, a second flat surface formed in another direction, and a third flat surface formed in another direction; and
a plurality of pontoons generating buoyancy on the sea by being connected to the node and elongated in three directions by being connected to the first flat surface, the second flat surface, and the third flat surface of the node, respectively,
wherein the node comprises a plurality of supporting members that protrudes upward from a bottom plate disposed at a predetermined distance under the top plate and of which at least one is elongated in a different direction, and the top plate is supported by the supporting members, so stress generated by load applied to the top plate by the wind turbine is distributed.

2. The arrangement of claim 1, wherein the supporting members comprise: a plurality of first supporting members that is horizontally elongated from the first flat surface and of which any one and another one are spaced apart from each other; a plurality of second supporting members that is elongated downward at an angle from the second flat surface toward the first supporting members and of which any one and another one are spaced apart from each other; and a plurality of third supporting members that is elongated upward at an angle from the third flat surface toward the first supporting members and of which any one and another one are spaced apart from each other.

3. The arrangement of claim 2, wherein the first supporting members, the second supporting members, and the third supporting members are each disposed such that a gap between any one and another one thereof decreases toward a middle portion from any one end in a longitudinal direction of the first flat surface, the second flat surface, and the third flat surface, respectively.

4. The arrangement of claim 2, wherein at least one of each of the first supporting members, the second supporting members, and the third supporting members is formed to have a different thickness.

5. The arrangement of claim 2, wherein at least one of each of the first supporting members, the second supporting members, and the third supporting members is formed to have a different length.

6. The arrangement of claim 1, wherein the node comprises a finishing plate elongated from an edge of the top plate to an edge of the bottom plate.

7. The arrangement of claim 6, wherein the finishing plate comprises a plurality of protrusions protruding from an inner surface of the finishing plate with an upper end thereof in contact with a bottom of the top plate and a lower end thereof in contact with a top of the bottom plate.
